(19) United States
(12) Patent Application Publication
(10) Pub. No.: US 2026/0236074 A1
(43) Pub. Date: Aug. 13, 2026

(54) SYSTEMS AND METHODS FOR CONTROLLING COOLING SYSTEMS OF INFORMATION HANDLING SYSTEMS

(71) Applicant: Dell Products L.P., Round Rock, TX (US)

(72) Inventors: Carlos Guillermo Henry, Georgetown, TX (US); Nadia Henry, Georgetown, TX (US); Rhushabh Bhandari, Pflugerville, TX (US); Sudhir Vittal Shetty, Cedar Park, TX (US); Kwangnam Cho, Round Rock, TX (US); Deepak Gowda, Raleigh, NC (US)

(73) Assignee: Dell Products L.P., Round Rock, TX (US)

(21) Appl. No.: 19/047,779

(22) Filed: Feb. 7, 2025

(51) Int. Cl. G06F 1/20; G05B 13/02

(52) U.S. Cl. CPC G06F 1/206; G05B 13/0265

(57) ABSTRACT

Systems and methods are provided for managing cooling of an information handling system (IHS). The system may include one or more processors, which run a Q-Learning agent to collect the telemetry data, take an action based on that data, and update a Q-Learning table based on an action taken. As a result, the fan speed or other cooling apparatus of the IHS may be controlled to remove heat from the IHS.

### FIELD

The present disclosure generally relates to Information Handling Systems (IHSs), and, more particularly, to controlling cooling systems of IHSs.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as servers, that are installed within chassis and stacked within slots provided by racks. A data center may include large numbers of such racks that are filled with servers, or other types of IHSs.

### SUMMARY

In various embodiments, an IHS (Information Handling System) includes: a plurality of managed hardware components; one or more processors; and one or more memory devices coupled to the one or more processors, the memory devices storing computer-readable instructions that, upon execution by the one or more processors, cause the IHS to: cause a cooling system of the IHS to operate according to a first operating characteristic; acquire telemetry data of the IHS, including a temperature error of the IHS, wherein the temperature error includes a difference between a detected temperature of the IHS and a target temperature of the cooling system; determine, based on the temperature error, a state of the cooling system and an action associated with the state from a state and action table; cause the cooling system to operate according to a second operating characteristic based on the action; and update the state and action table based on a reward.

In various embodiments, a method includes: acquiring telemetry data of an IHS (Information Handling System), including a temperature error of the IHS, wherein the temperature error includes a difference between a detected temperature of the IHS and a target temperature; determining, based on the temperature error, a state of the IHS and an action associated with the state from a state and action table; causing the IHS to operate according to an updated operating characteristic based on the action; and updating the state and action table based on a reward.

In various embodiments, a computer-readable storage device having instructions stored thereon for controlling a cooling system of an information handling system (IHS) wherein execution of the instructions by one or more processors of the IHS causes the one or more processors to: acquire an oscillation value of a cooling system of the IHS; determine, based on the oscillation value, a state of the IHS and an action associated with the state from a state and action table; cause the IHS to operate according to an updated operating characteristic based on the action; and update the state and action table based on a reward.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a diagram illustrating certain components of a chassis, according to some embodiments.

FIG. 2 is a diagram illustrating certain components of an IHS configured as a component of chassis, according to some embodiments.

FIG. 3 is an illustration of an example data center, according to some embodiments.

FIG. 4 is an illustration of an example method of operation for an example cooling agent, according to some embodiments.

FIG. 5 includes example graphs, illustrating temperature error and delta error as examples according to some embodiments.

FIG. 6 includes example graphs, illustrating fan oscillation and workload as examples according to some embodiments.

FIG. 7 is an illustration of an example state and action table, which may be used by a cooling agent, according to some embodiments.

FIG. 8 is an illustration of an example polynomial, which may be used by an example cooling agent, to set an operating characteristic of a cooling component, according to some embodiments.

FIG. 9 is an illustration of an example method, for cooling an IHS, according to some embodiments.

### DETAILED DESCRIPTION

Various embodiments provide systems and methods for controlling a cooling system for an information handling system (IHS). More specifically, various embodiments include a reinforcement learning (RL) system to manage cooling for an IHS.

Tuning some PID (Proportional-Integral-Derivative) closed-loop controllers for temperature regulation in servers may be challenging due to several limitations. Firstly, the tuning values in a PID controller may be used as factors that convert the temperature delta into PWM (Pulse Width Modulation) signals, which directly control the fan speed. This process may rely on the system's correlation to determine the appropriate amount of PWM and the speed at which it should be applied. However, the PID algorithm may operate in isolation from the broader system context—it may not consider CPU utilization, system configuration, sensor behavior, or other external factors that could influence its performance. Additionally, a change in temperature may result in a corresponding change in fan speed, but the PID controller may not inherently know whether this response is optimal. It may lack the capability to detect and correct negative response factors such as oscillation and overshoot. Moreover, PID controllers may not be self-adaptive so that each controller must be tuned for the specific application and set of conditions it will encounter. This means that any variation in operating conditions may cause retuning, making PID controllers less flexible and more time-consuming to manage in dynamic environments.

To overcome the limitations of PID closed-loop controllers in temperature regulation systems, a more advanced approach can be implemented using Q-Learning, a type of RL. Unlike fuzzy logic algorithms, which are computationally intensive and impractical for systems with numerous sensors, Q-Learning may offer a more efficient and adaptive solution. An example Q-Learning controller may utilize temperature error, workload, and/or a fan oscillation indicators as inputs to make decisions. The example algorithm may self-train and learn over time, continuously updating its state and action table based on state/action pairs and a reward system. The reward functions may incentivize maintaining the target temperature, minimizing fan speed, and avoiding oscillation patterns.

One implementation has a Q-Learning based controller including a self-tuning mechanism that incorporates workload and fan oscillation detection, in addition to temperature error monitoring. Such implementation may allow the controller to adapt dynamically and optimize fan speed and temperature regulation in real-time, thereby providing enhanced performance and efficiency across varying operating conditions usually without manual retuning. Thus, various implementations may allow for more efficient operation of an IHS through more optimized fan use.

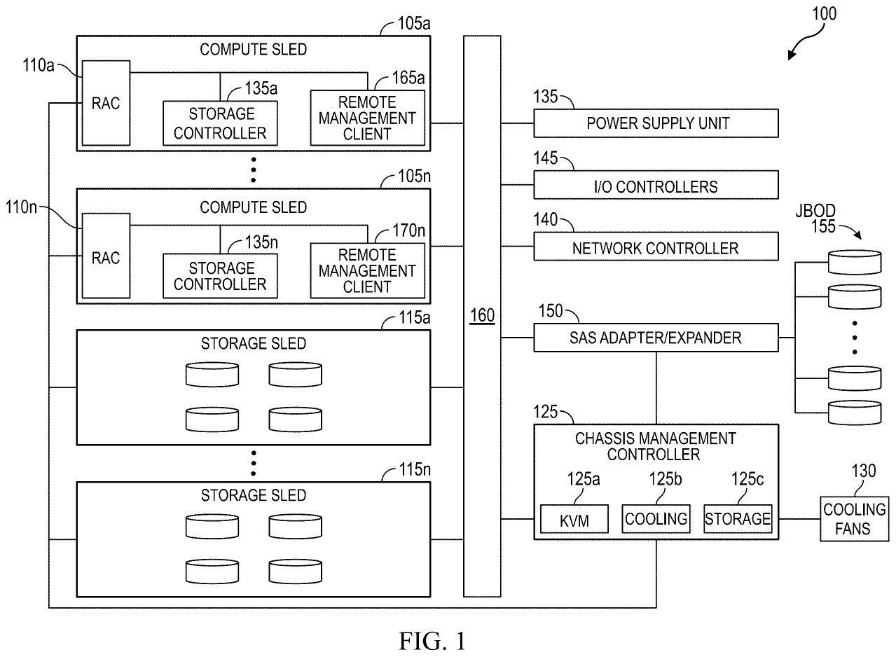

FIG. 1 is a block diagram illustrating certain components of a chassis 100 comprising one or more compute sleds 105a-n and one or more storage sleds 115a-n, where each of the sleds 105a-n, 115a-n may be configured to implement the systems and methods described herein to support controlling a cooling system of an IHS. Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

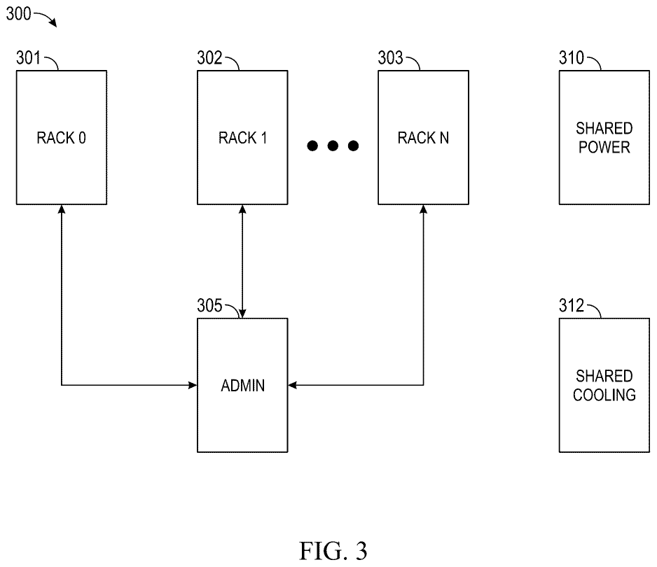

Multiple chassis 100 may be housed within a rack, such as any of the racks illustrated in FIG. 3. Data centers may utilize large numbers of racks, with various different types of chassis installed in the various configurations of racks. The modular architecture provided by the sleds, chassis and rack allow for certain resources, such as cooling, power and network bandwidth, to be shared by the compute sleds 105a-n and storage sleds 115a-n, thus providing efficiency improvements and supporting greater computational loads.

Chassis 100 may be installed within a rack structure that provides all or part of the cooling utilized by chassis 100. For airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air from within the sleds 105a-n, 115a-n installed within the chassis. A rack and a chassis 100 installed within the rack may utilize various configurations and combinations of cooling fans to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160. In various embodiments, backplane 160 may include various additional components, such as cables, wires, midplanes, backplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140 and power supply unit 135.

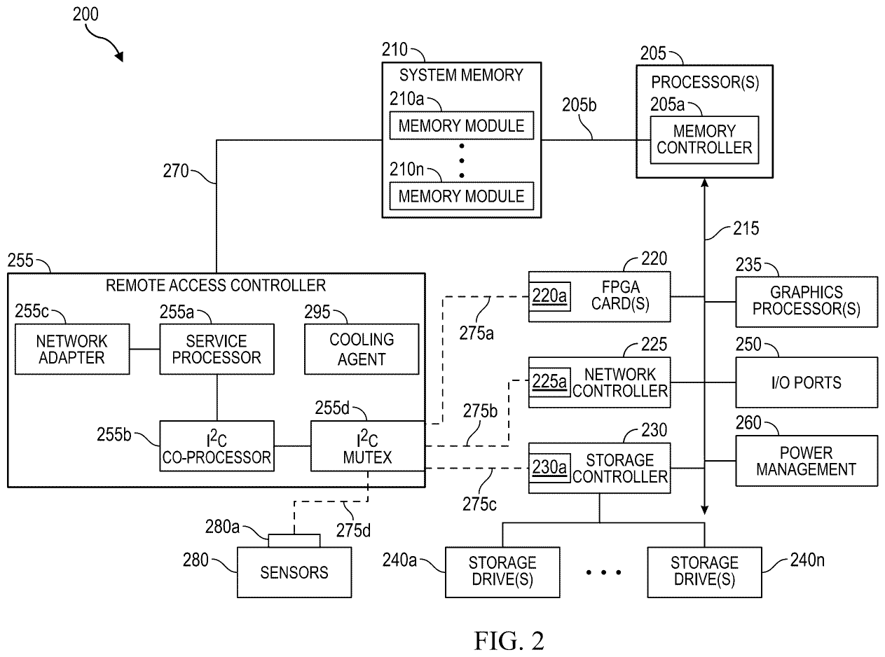

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n may be configured with hardware and software that provide leading-edge computational capabilities. Accordingly, services provided using such computing capabilities may be provided as high-availability systems that operate with minimum downtime. As described in additional detail with regard to FIG. 2, compute sleds 105a-n may be configured for general-purpose computing or may be optimized for specific computing tasks.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications with various components of a compute sled 105a-n and chassis 100. Remote access controllers 110a-n may collect sensor data, such as temperature sensor readings, from components of the chassis 100 in support of airflow cooling of the chassis 100 and the sleds 105a-n, 115a-n. Remote access controllers 110a-n may collect data, such as for power use, memory use, compute power use, clocking, sled configuration, and the like, for their respective sleds.

As illustrated, chassis 100 also includes one or more storage sleds 115a-n that are coupled to the backplane 160 and installed within one or more bays of chassis 200 in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. The storage sleds 115a-n may be utilized in various storage configurations by the compute sleds 105a-n that are coupled to chassis 100.

Each of the compute sleds 105a-n includes a storage controller 135a-n that may be utilized to access storage drives that are accessible via chassis 100. Some of the individual storage controllers 135a-n may provide support for RAID (Redundant Array of Independent Disks) configurations of logical and physical storage drives, such as storage drives provided by storage sleds 115a-n. In some embodiments, some or all of the individual storage controllers 135a-n may be HBAs (Host Bus Adapters) that provide more limited capabilities in accessing physical storage drives provided via storage sleds 115a-n and/or via SAS expander 150.

In addition to the data storage capabilities provided by storage sleds 115a-n, chassis 100 may provide access to other storage resources that may be installed components of chassis 100 and/or may be installed elsewhere within a rack housing the chassis 100, such as within a storage blade. In certain scenarios, such storage resources 155 may be accessed via a SAS expander 150 that is coupled to the backplane 160 of the chassis 100. The SAS expander 150 may support connections to a number of JBOD (Just a Bunch Of Disks) storage drives 155 that may be configured and managed individually and without implementing data redundancy across the various drives 155. The additional storage resources 155 may also be at various other locations within a data center in which chassis 100 is installed. Such additional storage resources 155 may also be remotely located.

As illustrated, the chassis 100 of FIG. 1 includes a network controller 140 that provides network access to the sleds 105a-n, 115a-n installed within the chassis. Network controller 140 may include various switches, adapters, controllers and couplings used to connect chassis 100 to a network, either directly or via additional networking components and connections provided via a rack in which chassis 100 is installed. Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units.

Chassis 100 may also include various I/O controllers 145 that may support various I/O ports, such as USB ports that may be used to support keyboard and mouse inputs and/or video display capabilities. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power 135, network bandwidth 140 and airflow cooling 130 that are available via the chassis 100. The airflow cooling 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a compute sled, a storage sled, a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein for controlling a cooling system. It should be appreciated that although the embodiments described herein may describe an IHS that is a compute sled or similar computing component that may be deployed within the bays of a chassis, other embodiments may be utilized with other types of IHSs that may also support controlling a cooling system. In the illustrative embodiment of FIG. 2, IHS 200 may be a computing component, such as compute sled 105a-n or other type of server, such as a 1 RU server installed within a 2 RU chassis, that is configured to share infrastructure resources provided by a chassis 100.

In an example implementation, the chassis management controller 125 (FIG. 1) may cause the cooling module 125b to change a characteristic of operation based upon communications with remote access controller 255. For instance, one example implementation may include the cooling module 125b controlling the cooling fans 130, such as by providing pulse width modulation (PWM) signals that cause the motors of cooling fans 130 to operate at a desired revolutions per minute (RPM). The remote access controller 255 may execute computer-readable instructions to run the cooling agent 295 and may transmit signals to the chassis management controller 125 to change the PWM to cause a change in the RPM of the cooling fans 130 according to output of the cooling agent 295.

The IHS 200 of FIG. 2 may be a compute sled, such as compute sleds 105a-n of FIG. 1, that may be installed within a chassis, that may in turn be installed within a rack. Installed in this manner, IHS 200 may utilize shared power, network and cooling resources provided by the chassis and/or rack. IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b.

The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty components. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources or other peripheral components.

As illustrated, IHS 200 may include one or more FPGA (Field-Programmable Gate Array) card(s) 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of the logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as computing different operations that are being offloaded from processor 205. The FPGA card 220 may also include a management controller 220a that may support interoperation with the remote access controller 255 via a sideband device management bus 275a.

Processor(s) 205 may also be coupled to a network controller 225 via in-band bus 215, such as provided by a Network Interface Controller (NIC) that allows the IHS 200 to communicate via an external network, such as the Internet or a LAN. In some embodiments, network controller 225 may be a replaceable expansion card or adapter that is coupled to a motherboard connector of IHS 200. In some embodiments, network controller 225 may be an integrated component of IHS 200.

A variety of additional components may be coupled to processor(s) 205 via in-band bus 215. For instance, processor(s) 205 may also be coupled to a power management unit 260 that may interface with the power system unit 135 of the chassis 100 in which an IHS, such as a compute sled, may be installed. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255.

In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the IHS 200 (i.e., in a bare-metal state).

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies. As a non-limiting example of a remote access controller, the integrated Dell Remote Access Controller (iDRAC) from Dell® is embedded within Dell PowerEdge™ servers and provides functionality that helps information technology (IT) administrators deploy, update, monitor, and maintain servers remotely.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as FPGA cards 220, network controller 225 and storage controller 230, are coupled to the IHS processor(s) 205 via an in-line bus 215, such as a PCIe root complex, that is separate from the I2C sideband bus connections 275a-d used for device management. In various embodiments, additional or different components of IHS 200 may be managed by remote access controller 225 through the use of sideband bus connections. The management functions of the remote access controller 255 may utilize information collected by various managed sensors 280 located within the IHS. For instance, temperature data collected by sensors 280 (as well as any other appropriate data) may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280.

In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280. In certain embodiments, the endpoint I2C controller 280a of the FPGA card 220 may correspond to the management controller 220a described above.

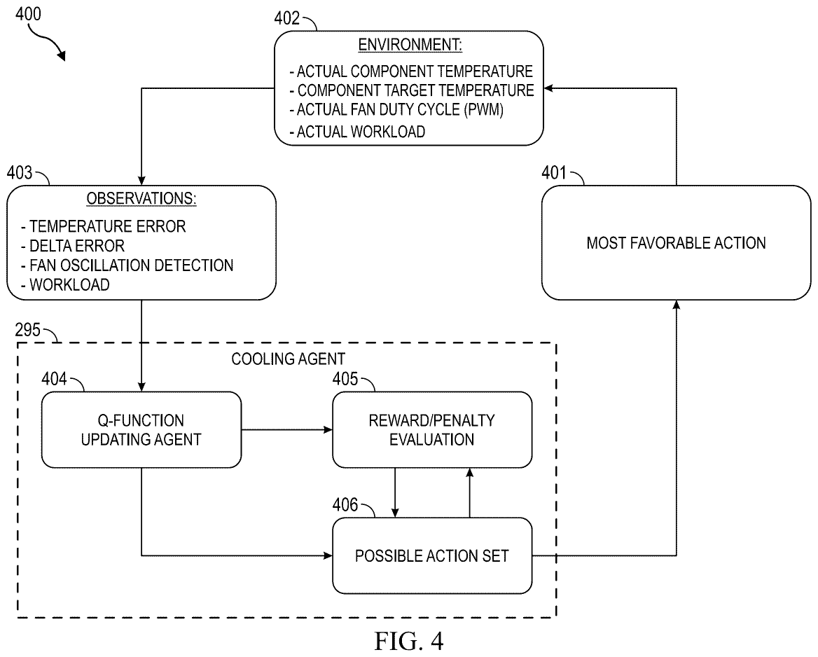

In some examples, the service processor 255a may be configured to execute computer-readable instructions to implement the functionality of cooling agent 295. The operation of cooling agent 295 is described in more detail with respect to FIGS. 4-9. In short, cooling agent 295 may be configured as a Q-Learning agent having the ability to control the cooling resources of the IHS 200. In an example in which the IHS 200 relies upon rack or chassis cooling resources (e.g., cooling fans 130 and cooling controller 125b), the cooling agent 295 may cause the remote access controller 255 to provide signaling to the chassis management controller 125 to adjust a PWM signal for the cooling fans 130. In that manner, the cooling agent 295 may set and change operating characteristics of the cooling of IHS 200.

However, the scope of implementations is not limited only to an IHS in a rack or in a chassis. Rather, some IHS implementations (e.g., laptop and desktop computers) may include their own cooling systems, such as fans and liquid cooling systems. In such an implementation, the remote access controller 255 may be used to control the operating characteristic of the cooling system without having to go through the chassis management controller 125.

Furthermore, while the example of FIG. 2 illustrates the remote access controller 255 and its service processor 255a as executing computer-readable instructions to implement cooling agent 295, other embodiments may use any appropriate processing device, such as any of the processors 205 or other available processing resources (not shown), to execute computer-readable instructions to implement cooling agent 295.

Also, while the examples herein illustrate use cases focusing on controlling fan speed, via PWM signals, other implementations may control other aspects of the cooling system. For instance, other implementations may use cooling agent 295, with appropriate inputs, to control fluid flow speed or volume through a liquid cooling system, control an array of fans, and/or the like.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

FIG. 3 is an illustration of an example data center 300, according to some embodiments. Data center 300 includes N racks 301-303, where N is a positive integer greater than one, though this particular illustration shows three racks 301-303. However, the scope of implementations may include any appropriate quantity N of racks.

Each of the racks 301-303 may include one or more chassis, where an example chassis 100 is described above with respect to FIG. 1. Each chassis in a rack may include one or multiple IHSs, such as one or multiple compute sleds, storage sleds, or the like. In some examples, an IHS in a rack may be referred to as a server, though the scope of implementations is not limited to servers.

Admin computing rack 305 may include one or multiple chassis having one or multiple IHSs that run applications for administration of the data center. Shared power resource 310 may include power converters, buses, and the like, to provide power to the racks 301-303, the admin rack 305, shared cooling resource 312, and any other components of the data center 300. For instance, shared power resource 310 may receive electricity from a power line (not shown) or substation (not shown), which is external to the data center 300 and then distribute that power to the various components within the data center.

Shared cooling resource 312 may include various data center-level cooling technologies, which support heat removal from racks 301-303, admin rack 305, shared power resource 310, and any other appropriate components of data center 300. In one example, shared cooling resource 312 may include a central air conditioning system, which operates to keep the data center 300 within a specified temperature range (e.g., 15° C.-32° C.). Shared cooling resource 312 may include other technologies, such as central fluid cooling, where fluid from one or more of the racks 301-303 may circulate through shared cooling resource 312 to 4 heat to be removed in the fluid to be recirculated.

Admin rack 305 may include an IHS (not shown), which communicates with individual ones of the IHSs of the racks 301-303. For instance, in one example, the various IHSs within rack 301 may communicate with an IHS of admin 305 over a network, such as ethernet or a wireless network such as Wi-Fi. Example, each of the IHSs may include a remote access controller, which in some implementations may also be referred to as a baseboard management controller (BMC). The remote access controller for a given IHS may monitor configuration of the IHS, monitor performance characteristics of the IHS, and control some operations of various components of the IHS. Furthermore, a given IHS may transmit remote access controller data to an IHS of the admin rack 305, and the IHS of the admin rack 305 may communicate to an IHS of a given rack to cause action on the part of the remote access controller.

Various embodiments may include an IHS configured to provide cooling agent functionality in any appropriate configuration. For instance, each of the IHSs in a chassis or in a rack may be individually configured to provide cooling agent functionality. In another example, one or more IHSs may be in charge of managing cooling for an entire chassis or an entire rack, such that one or more IHSs may implement the functionality of a cooling agent on behalf of other IHSs in the rack or chassis. Furthermore, the various IHSs in the admin rack 305 may also be configured to include cooling agent functionality. And as noted above, cooling agent functionality may be included in standalone IHSs, such as laptop computers, desktop computers, and/or the like.

FIG. 4 is an illustration of an example method 400 of operation for an example cooling agent 295, according to some embodiments. In the present example, the cooling agent 295 is configured as a Q-Learning agent, which is a type of reinforcement learning (RL) application. In short, cooling agent 295 learns by interacting with its environment to obtain an optimal strategy for achieving its goals. In this example, the environment is the IHS, and the goals are optimal cooling of the IHS.

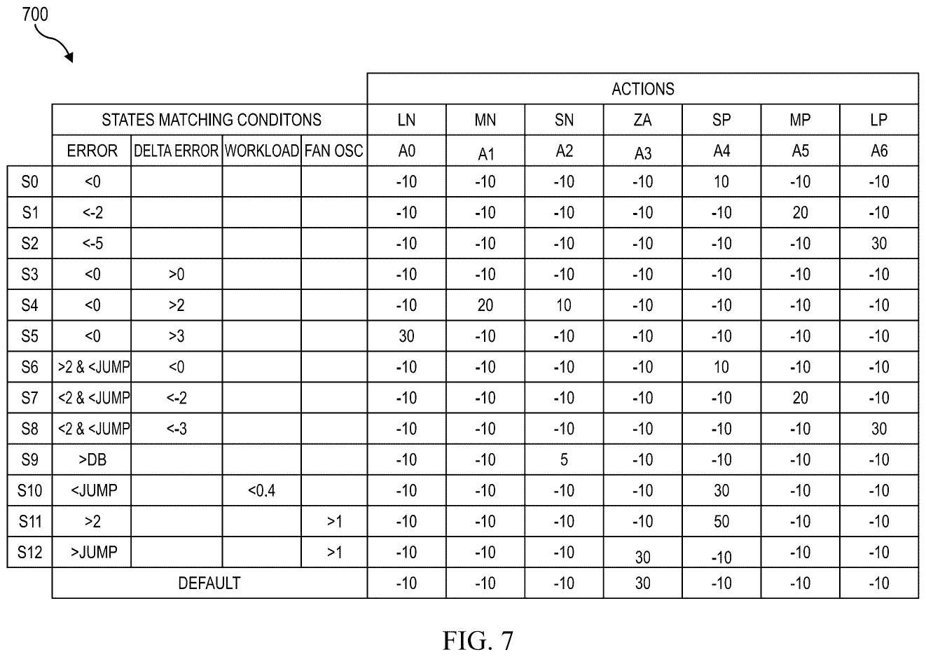

At operation 401, the cooling agent 295 performs a selected action, which is selected from a state and action table (as described in more detail at FIG. 7). For instance, the selected action may result in a change in a duty cycle of a PWM signal, thereby changing an RPM of a fan (e.g., fan 130 of FIG. 1). In one example, the selected action may result in an increase in the duty cycle of the PWM signal, which would be expected to increase the RPMs of the fan, or the selected action may result in a decrease in the duty cycle, which would be expected to decrease the RPMs of the fan. Generally, it would be expected that the higher the RPMs of a fan, the more heat that the fan would remove from the internal components of the IHS, but the increased RPMs would come with a higher cost of energy to run the fans as well as increased acoustic noise. By contrast, it would generally be expected that the lower the RPMs of the fan, the less heat that would be removed, though the fan would be expected to use less energy and to create less acoustic noise.

At operation 402, the cooling agent 295 receives telemetry information from the environment. For instance, in the example of FIG. 2, the remote access controller 255 may have access to a variety of different sensors, which may generate telemetry data, such as temperature information, a target temperature, duty cycle of the fan, workload of the IHS, and/or the like.

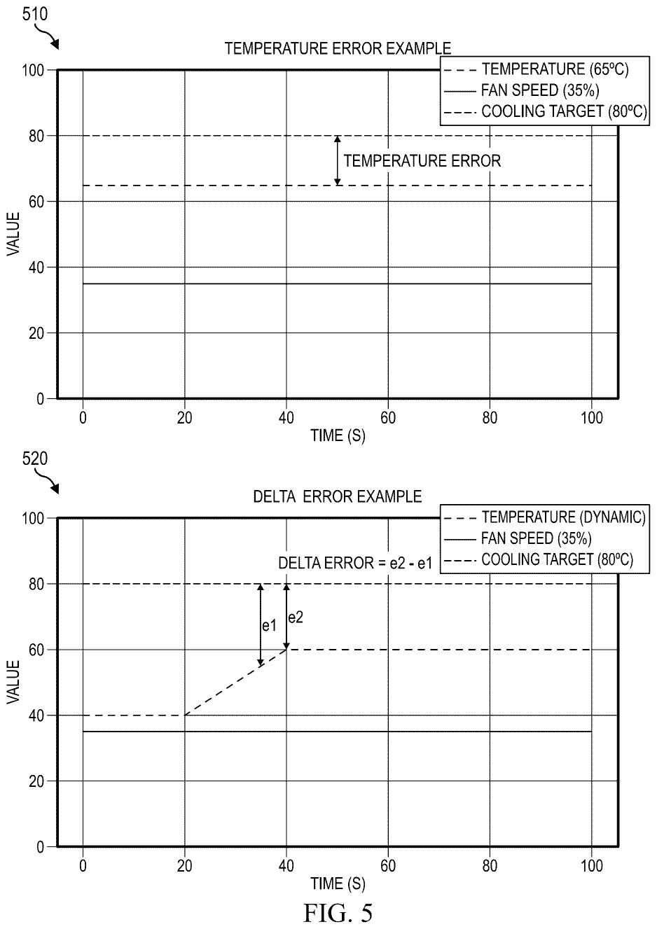

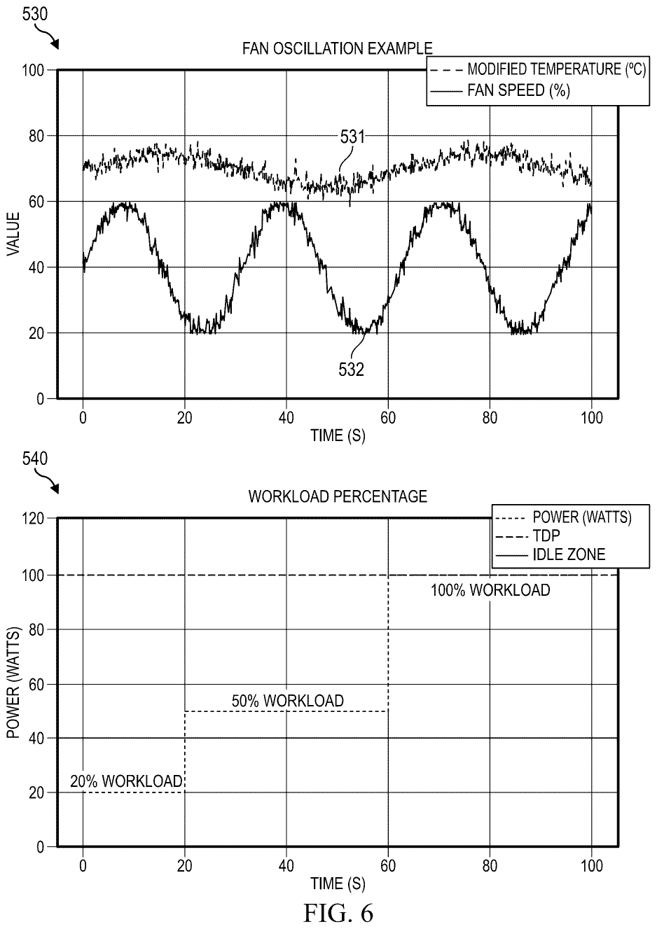

At operation 403, the cooling agent 295 analyzes the telemetry data from operation 402, thereby generating resulting analyzed data based on the telemetry data. Examples of the analyzed data may include temperature error, delta error, fan oscillation detection, and workload. The analyzed data is described in more detail with respect to FIGS. 5-6.

FIG. 5 includes example graphs 510 and 520, illustrating temperature error and delta error as examples according to some embodiments. Similarly, FIG. 6 includes example graphs 530 and 540, illustrating fan oscillation and workload as examples according to some embodiments.

The temperature error of graph 510 includes a target temperature minus a current temperature measurement. Therefore, when the current temperature is above the target temperature, the temperature error is negative and when the current temperature is below the target temperature, the temperature error is positive.

The delta error of graph 520 illustrates a difference between a current temperature error and a previously-measured temperature error. In the example of graph 520, that is e2 minus e1. As an absolute value of the delta error decreases, that indicates a convergence of the system to ward the target temperature.

The fan oscillation of graph 530 shows two different waveforms. A first wave form 531 illustrates an observed temperature of the IHS, and a second wave form 532 illustrates fan speed as a percentage of full fan speed. Waveform 532 appears as a sinusoid, having peaks and troughs between about 20% and 60% of fan speed. In other words, waveform 532 illustrates a phenomenon referred to as fan oscillation, where the fan speed bounces between peaks and troughs. The waveform 531 also appears as a sinusoid, though having a lower frequency than a frequency of the sinusoid of waveform 532. Various embodiments seek to minimize a frequency and amplitude of a sinusoid that represents the fan speed, such as is shown in waveform 532. Specifically, in some implementations, the fan oscillation of waveform 532 may indicate inefficiency of fan operation. Put another way, fan oscillation of waveform 532 may indicate that a power use of a fan may be undesirably high relative to the amount of thermal energy that the fan removes from the IHS.

In one example, fan oscillation may be calculated by storing a fan duty PWM with N historical values, where N is a positive integer sufficiently large enough to give an indication of whether there have been peaks and troughs. Then, the cooling agent 295 may calculate a standard deviation of the N values. The cooling agent 295 may also count peaks and troughs (valleys) in the N values, where a peak is detected when a smoothed average of waveform 532 goes from increasing to decreasing, and a valley is detected when a smoothed average of waveform 532 goes from decreasing to increasing. An oscillation score may be calculated using Equation 1:

$$Fan\_Osc = {( fPeaks + fValleys )}^{*} fSTDEV , \qquad Eq . ( 1 )$$

where fPeaks is a quantity of peaks, fValleys is a quantity of valleys, and fSTDEV is the standard deviation of the N historical values.

The workload of graph 540 illustrates operation of the IHS in power consumed by the components of the IHS. Furthermore, the workload is given in percentage of a maximum workload. Graph 540 illustrates the workload stepping between 20%, 50%, and 100%. In one example use case, the workload of the IHS may increase as the IHS performs more operations per second and may decrease as the IHS performs fewer operations per second. The workload may be affected by operation of processors, memory, storage devices, network cards, and the like.

Returning to FIG. 4, the observations of operation 403 refer to the analyzed data. Examples of the analyzed data include the temperature error, delta error, fan oscillation, and workload of FIGS. 5-6. The cooling agent 295 inputs the analyzed data into the Q-function updating agent 404. The Q-function updating agent 404 then operates with the reward penalty evaluation function 405 and the possible action set function 406 to determine a state of the cooling system of the IHS and an action associated with the state. The reward penalty evaluation function 405 may determine a reward (discussed in more detail with respect to FIG. 9) and may update the state and action table. As a result, the cooling agent 295 may determine an appropriate action to take and may also update its state and action table, repeating the process with each action and with new data received.

FIG. 7 is an illustration of an example state and action table 700, which may be used by cooling agent 295 in a closed-loop Q-Learning process, according to some embodiments. In this example, the columns labeled ACTIONS provide the possible action sets discussed above with respect to possible action set operation 406. In table 700, there are four columns, labeled ERROR, DELTA ERROR, WORKLOAD, and FAN OSC. Those columns refer to error, delta error, workload, and fan oscillation, discussed above with respect to FIGS. 5-6. Each row in table 700 refers to a respective one of the states S0-S12 or DEFAULT.

Each of the cells in the rows labeled ERROR, DELTA ERROR, WORKLOAD, and FAN OSC refers to a condition that, if true, may indicate that the respective state applies. For instance, looking at state S0, it applies if the error is less than zero in the observations from operation 403. The other states S1-S12 have similar conditions, and those states apply if the conditions match the observations from operation 403. DB refers to the cooling system being in a “no adjustment” zone, and JUMP represents an error value or margin to use while the workload is less than 40%. The margin may allow the fan to increase in RPMs by an appropriate amount when the IHS is at an idle state and the temperature is close to the target temperature.

If no other state applies, then the DEFAULT row applies. It may be possible that the observations from operation 403 indicate that more than one state applies (e.g., has true conditions). In such a situation, the cooling agent 295 may analyze the values in the respective ACTIONS columns of the states that apply and pick a single state having a highest single value within its respective row. As an example, if the conditions of both state S0 and S9 are satisfied so that both states apply, then the cooling agent 295 may go through the S0 row to determine that the highest value is 10 (SP column) and may go through the S9 row to determine that the highest value is 5 (SN column). Since 10 is greater than 5, then the cooling agent 295 determines that the cooling system is in state S0. Of course, that is just one example, and the cooling agent 295 may use the same analysis to determine an applicable state when more than one state has conditions that are satisfied.

Each of the cells in the ACTIONS columns includes a value (also called Q values), where that respective value is a reward score. Each of the ACTIONS columns is associated with an action.
Action A0 (LN): Adjust the fans by a delta of “Large Negative”, which means decrease at “Large” rate.
Action A1 (MN): Adjust the fans by a delta of “Median Negative”, which means decrease at “Median” rate.
Action A2 (SN): Adjust the fans by a delta of “Small Negative”, which means decrease at “Small” rate.
Action A3 (ZA): “Zero Adjustment” to be applied, which means “Do not change” fan speed.
Action A4 (SP): Adjust the fans by a delta of “Small Positive”, which means increase at “Small” rate.
Action A5 (MP): Adjust the fans by a delta of “Median Positive”, which means increase at “Median” rate.
Action A6 (LP): Adjust the fans by a delta of “Large Positive”, which means increase at “Large” rate.

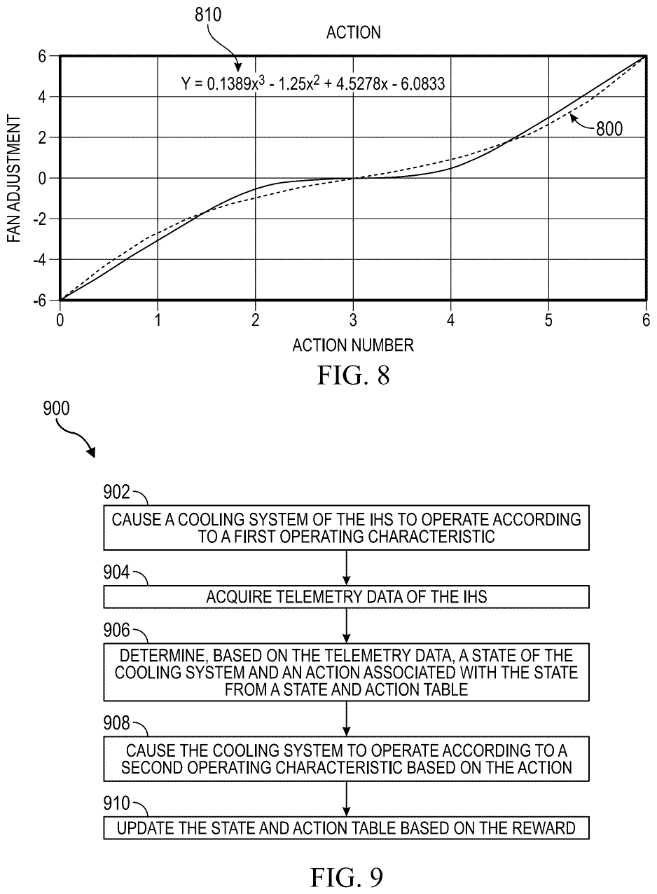

Once it is determined that a particular state applies, then the cooling agent 295 parses through the ACTIONS columns in the row of that state to pick the highest Q value. For instance, if state S9 is determined to be the current state, then the cooling agent 295 parses the entries in the S9 row to select the highest value in the S9 row. In this example, the highest value is 5 (i.e., 5 is greater than −10). The value 5 corresponds to action A2, which is small negative. The cooling agent 295 then applies 2 to the polynomial 810 of FIG. 8. In this example, each of the actions is associated with its respective numeral, so that action A0 refers to 0, action A1 refers to 1, action A2 refers to 2, and so on. Thus, if cooling agent 295 determines that action A2 applies, then cooling agent 295 substitutes a value of 2 for x in the polynomial 810. Polynomial 810 is given by Equation 2.

$$y = 0.1389 {x}^{3} - 1.25 {x}^{2} + 4.5278 x - 6.083 . \qquad Eq . ( 2 )$$

When using polynomial 810, the resulting value may be used as an increment or decrement of a current percentage of PWM duty cycle for a fan. Further in this example, the possible values of polynomial 540 span from −6 to 6. Continuing with the example use case, applying a value of 2 for x results in a value of the polynomial 810 of −0.9165, or approximately −1. So if the PWM duty cycle of the fan is at 50%, then the cooling agent 295 would cause the duty cycle of the fan to be reduced by 0.9165%.

The example polynomial 810 may be determined during development of a particular system, such as by experimentation or simulation. For instance, there may be multiple possible polynomials that would be used, and a designer may choose a polynomial that provides the best results (or, at least, acceptable results).

The cooling agent 295 takes the action, which may include increasing or decreasing the PWM duty cycle of the fan, as described above. The cooling agent 295 may also adjust the state and action table 700.

In one example, the cooling agent 295 executes the chosen action (aₜ) in the environment. The environment (the cooling system of the IHS) responds with the next state (sₜ+1) and a reward term (rₜ) based on the quality of the action. The Q value for the chosen state action pair may then be updated by the cooling agent 295 using any appropriate technique. One example technique may include using the Bellman equation (Equation 3).

$$Q ( {s}_{t} , {a}_{t} ) ← Q ( {s}_{t} , {a}_{t} ) + α [ {r}_{t} + γ {max}_{a} Q ( {s}_{t + 1} , a ) - Q ( {s}_{t} , {a}_{t} ) ] \qquad Eq . ( 3 )$$

where α is a learning rate programmed to the cooling agent 295 and y is a discount factor that balances the importance of immediate and future rewards. The current estimate is given as Q(sₜ, aₜ), and the future estimate is given by maxₐ*Q(sₜ₊₁, a).

Further in the example, the goals of the cooling agent 295 may be set for any appropriate goals, such as 1) ensuring IHS temperatures do not go above a critical limit, 2) controlling the temperature of the IHS to be at or below a cooling target (e.g., 0 error), while keeping the fan at a lowest possible speed, and 3) ensuring no fan oscillation is detected. In the example above of FIGS. 4-8, a reward function closest to zero may indicate the response is efficient and optimal, and a reward function further from zero may indicate a lack of efficiency and a lack of optimal cooling. In one example, the reward term (rₜ) may be determined as follows in the pseudocode:

```
(rₜ) = (error, fan_osc, PWM):
if error < 0:
  return -100
else:
  return -error − (0.1*fan_osc) − (0.1*PWM).
```

A cooling agent may update the table 700 accordingly and move to the next state (sₜ+1) and repeat the process shown in FIG. 4 until a termination condition is met, such as by reaching a goal or reaching a maximum number of cycles. In one example, it is possible that the cooling agent 295 may reach a termination condition, such as reaching a zero adjustment action (Action A3) a pre-programmed number of times. However, a physical condition of the IHS may change, thereby forcing the cooling agent 295 to adapt accordingly. An example of a physical condition of the IHS changing may include an example in which the IHS is deployed in a rack (e.g., racks 301 of FIG. 1), and a cover of the rack is removed, thereby changing airflow qualities. The reinforced learning nature of the cooling agent 295 may then adapt by determining certain states apply and then updating the table 700 through multiple cycles to eventually reach minimal or zero adjustment.

A potential advantage of some embodiments may include the ability to provide efficient operation, such as maximizing cooling subject to a constraint of efficiently operating a fan or other cooling component. Yet another potential advantage may include the ability to adapt to changed physical conditions of the IHS, such as described above. By contrast, a PID control system may be optimized for only a single physical condition and may provide undesired operation when that physical condition changes.

FIG. 9 is an illustration of an example method 900, for cooling an IHS, according to some embodiments. In one example, method 900 may be performed by a processing component, such as a CPU, GPU, a processor in a remote access controller, or other appropriate component to implement the functionality of cooling agent 295.

At action 902, the cooling agent may cause a cooling system of the IHS to operate according to a first operating characteristic. Operating characteristics may include, e.g., a PWM percentage, which directly affects RPM of one or more fans, a flow rate of cooling fluid in a cooling system, opening or closing valves or other apparatus to increase or decrease flow rate of a cooling fluid (liquid or gas), and/or the like. In the example of FIGS. 4-8, the operating characteristic may include operating one or more fans according to a PWM duty cycle percentage and in response to an action determined using table 700.

At action 904, the cooling agent acquires telemetry data of the IHS. An example is discussed above with respect to operations 402 and 403 of FIG. 4, which may provide analyzed data, such as described with respect to FIGS. 5-6.

At action 906, the cooling agent determines, based on the telemetry data, a state of the cooling system and an action associated with the state from a state and action table. An example is provided above with respect to FIG. 7, in which the analyzed data leads to a determination of a state and a determination of an action corresponding to that state.

At action 908, the cooling agent causes the cooling system to operate according to a second operating characteristic based on the action. As one example, the state and action determined at action 908 may lead to adjusting the cooling system, such as by applying a value to a pre-programmed polynomial (e.g., polynomial 810) to determine a new operating characteristic. In the example of FIG. 8, the new operating characteristic may include an increased or decreased PWM duty cycle percentage. However, as noted above the scope of implementations may include other operating characteristics, and action 908 may include adjusting those operating characteristics.

At action 910, the cooling agent updates the state and action table based upon a reward. For instance, the cooling agent may determine a reward term and then use a technique, such as applying a Bellman equation or other appropriate function, to update a Q value of the table.

The scope of implementations is not limited to the series of actions shown in FIG. 9. Rather, various implementations may omit, rearrange, modify, or add one or more actions. For instance, after performing action 910, the cooling agent may loop back to action 904, determine a state and action at action 906, adjust operation of the cooling system at action 908, update at action 910, and then loop back again to action 904.

Such looping back may be performed as many times as is appropriate. Furthermore, as a physical condition of the IHS changes, the looping back may be repeated to adapt to the changed physical conditions.

In some examples, it may be desirable to facilitate continuous learning, even though the cooling agent may have converged on a zero adjustment action. In one example, data augmentation may be used. Data augmentation may include using a synthetic data set, added to existing data. One technique for data augmentation is referred to as synthetic minority over-sampling technique (SMOTE). Such technique may include generating synthetic data from a minority class of a data set, rebalancing the overall training data through oversampling. Furthermore, such technique may include randomly selecting a minority class instance and synthesizing new data based on its K nearest neighbors, where K is a positive integer greater than zero. In one example, the Python SMOTE( ) function from the imbalanced-learn package provides this capability, allowing the creation of synthetic datasets by mapping defined states to the minority class. Another technique may include feature engineering, which may involve creating new features or transforming existing features to better capture patterns in a data set. For instance, additional features derived from defined states can help identify new data patterns, enhancing a model's learning mechanism. In yet another example, some ensemble methods may be used, such as integrating additional models into an existing model. Techniques such as boosting, bagging, and stacking may be used to combine new models with an existing model.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An IHS (Information Handling System) comprising:
a plurality of managed hardware components;
one or more processors; and
one or more memory devices coupled to the one or more processors, the memory devices storing computer-readable instructions that, upon execution by the one or more processors, cause the IHS to:
cause a cooling system of the IHS to operate according to a first operating characteristic;
acquire telemetry data of the IHS, including a temperature error of the IHS, wherein the temperature error includes a difference between a detected temperature of the IHS and a target temperature of the cooling system;
determine, based on the temperature error, a state of the cooling system and an action associated with the state from a state and action table;
cause the cooling system to operate according to a second operating characteristic based on the action; and
update the state and action table based on a reward.

2. The IHS of claim 1, wherein the one or more processors are included in a remote access controller of the IHS.

3. The IHS of claim 1, wherein the state and action table is associated with a closed-loop Q-Learning process.

4. The IHS of claim 1, wherein the computer-readable instructions to cause the IHS to determine the state of the cooling system includes computer-readable instructions to determine state of the cooling system based further on a delta value of the error.

5. The IHS of claim 1, wherein the computer-readable instructions to cause the IHS to determine the state of the cooling system includes computer-readable instructions to determine state of the cooling system based further on an oscillation value of the cooling system.

6. The IHS of claim 1, wherein the computer-readable instructions to cause the IHS to determine the state of the cooling system includes computer-readable instructions to determine state of the cooling system based further on a workload of the IHS.

7. The IHS of claim 1, wherein the computer-readable instructions to cause the IHS to cause the cooling system to operate according to the second operating characteristic comprises computer-readable instructions to cause the IHS to:
determine an action value associated with the action;
apply the action value to a polynomial function; and
apply a result of the polynomial function to a control system of the cooling system.

8. The IHS of claim 7, wherein the computer-readable instructions to cause the IHS to apply the result of the polynomial function to the control system comprises computer-readable instructions to cause the IHS to adjust a pulse width modulation (PWM) value according to the result of the polynomial function, and wherein the PWM value controls a fan speed of the cooling system.

9. The IHS of claim 1, wherein the first operating characteristic comprises a first pulse width modulation (PWM) value at which a fan motor is operated, and wherein the second operating characteristic includes a second PWM value at which the fan motor is operated, wherein the first PWM value is different from the second PWM value.

10. The IHS of claim 1, wherein the reward is based on a value of the temperature error being positive or negative.

11. A method comprising:
acquiring telemetry data of an IHS (Information Handling System), including a temperature error of the IHS, wherein the temperature error includes a difference between a detected temperature of the IHS and a target temperature;
determining, based on the temperature error, a state of the IHS and an action associated with the state from a state and action table;
causing the IHS to operate according to an updated operating characteristic based on the action; and
updating the state and action table based on a reward.

12. The method of claim 11, wherein the operating characteristic includes a speed of a fan of the IHS.

13. The method of claim 11, wherein the operating characteristic includes a fluid flow speed or volume of a cooling system of the IHS.

14. The method of claim 11, further comprising:
determining the reward based upon a value of the temperature error.

15. A computer-readable storage device having instructions stored thereon for controlling a cooling system of an information handling system (IHS), wherein execution of the instructions by one or more processors of the IHS causes the one or more processors to:
acquire an oscillation value of a cooling system of the IHS;
determine, based on the oscillation value, a state of the IHS and an action associated with the state from a state and action table;
cause the IHS to operate according to an updated operating characteristic based on the action; and
update the state and action table based on a reward.

16. The computer-readable storage device of claim 15, further comprising instructions to cause the one or more processors to:
determine the reward based upon a temperature error, wherein the temperature error includes a difference between a detected temperature of the IHS and a target temperature.

17. The computer-readable storage device of claim 15, wherein the operating characteristic includes a fan speed of a cooling system of the IHS.

18. The computer-readable storage device of claim 15, wherein the state and action table is associated with a closed-loop Q-Learning process.

19. The computer-readable storage device of claim 15, wherein the instructions to cause the IHS to cause the cooling system to operate according to the updated operating characteristic comprises instructions to cause the IHS to:
determine an action value associated with the action;
apply the action value to a polynomial function; and
apply a result of the polynomial function to a control system of the cooling system.

20. The computer-readable storage device of claim 19, wherein the instructions to cause the IHS to apply the result of the polynomial function to the control system comprises instructions to cause the IHS to adjust a pulse width modulation (PWM) value according to the result of the polynomial function, and wherein the PWM value controls a fan speed of the cooling system.
